(19) United States
(12) Patent Application Publication
(10) Pub. No.: US 2024/0381427 A1
(43) Pub. Date: Nov. 14, 2024

(54) URGENT DATA TRANSFER USING SHORT PHYSICAL LAYER PROTOCOL DATA UNIT BURSTS

(71) Applicant: Apple Inc., Cupertino, CA (US)

(72) Inventors: Jinjing Jiang, San Jose, CA (US); Ahmad Reza Hedayat, Carlsbad, CA (US); Jarkko L. Kneckt, Los Gatos, CA (US); Lochan Verma, Danville, CA (US); Qi Wang, Sunnyvale, CA (US); Sidharth R. Thakur, San Jose, CA (US); Su Khiong Yong, Palo Alto, CA (US); Tianyu Wu, Fremont, CA (US); Yong Liu, Campbell, CA (US)

(21) Appl. No.: 18/638,151

(22) Filed: Apr. 17, 2024

Related U.S. Application Data
(60) Provisional application No. 63/465,726, filed on May 11, 2023.

(51) Int. Cl. H04W 74/0816; H04L 5/00; H04W 74/06

(52) U.S. Cl. CPC H04W 74/0816; H04L 5/0053; H04W 74/06

(57) ABSTRACT

Disclosed are methods, systems, and computer-readable medium to perform operations including: during transmission of two or more physical layer protocol data units (PPDUs) during a transmission opportunity (TXOP), determining that an urgent PPDU should be transmitted during the TXOP; and enabling, before transmission of all of the two or more PPDUs during the TXOP, transmission of the urgent PPDU.

### BACKGROUND

Many electronic devices communicate with each other using wireless local area networks (WLANs), such as those based on a communication protocol that is compatible with an Institute of Electrical and Electronics Engineers (IEEE) standard, e.g., the IEEE 802.11 standard (also known as “Wi-Fi”). A WLAN typically includes an access point that provides one or more stations (STAs) with access to another network, such as the Internet. There are many generations of the IEEE 802.11 standard, including 802.11ax (Wi-Fi 6) and 802.11be (Wi-Fi 7). IEEE 802.11 is a packet-based protocol. Under this protocol, a transmitter, e.g., an access point (AP), packages control information or user data into a protocol data unit (PDU) in a physical layer convergence protocol (PLCP). The PLCP PDU (PPDU) includes a preamble and a data field, among other fields. After generating the PPDU, the access point can transmit the PPDU to a station connected to the access point. Communication from the access point to a station is referred to as the downlink, and the communication from a station to the access point is referred to as the uplink.

### SUMMARY

In accordance with one aspect of the present disclosure, during transmission of two or more physical layer protocol data units (PPDUs) during a transmission opportunity (TXOP), determining that an urgent PPDU should be transmitted during the TXOP; and enabling, before transmission of all of the two or more PPDUs during the TXOP, transmission of the urgent PPDU.

In accordance with one aspect of the present disclosure, transmitting, during a transmission opportunity (TXOP), a first physical layer protocol data unit (PPDU) of two or more PPDUs each of which are scheduled for transmission during the TXOP; determining that an urgent PPDU should be transmitted during the TXOP; and transmitting, before transmission of all of the two or more PPDUs during the TXOP, the urgent PPDU that has a duration that fits in a TXOP and that was not included in the two or more PPDUs.

The foregoing and other embodiments can each optionally include one or more of the following features, alone or in combination. In some implementations, the method can include receiving a block acknowledgement (BA) for the urgent PPDU; and receiving a single BA for at least two of the two or more PPDUs.

In some implementations, the duration of the urgent PPDU can fit into a remaining TXOP duration for a TXOP for which another PPDU has already been sent.

In some implementations, the method can include, after enabling the transmission of the urgent PPDU, transmitting at least two of the two or more PPDUs. Receiving the single BA can include receiving the single BA for the two of the two or more PPDUs. Transmitting the at least two of the two or more PPDUs can include transmitting a first PPDU before transmitting the urgent PPDU, and transmitting a second PPDU after transmitting the urgent PPDU.

In some implementations, determining that the urgent PPDU should be transmitted during the TXOP comprises determining that the urgent PPDU with an approximately 1 millisecond delay bound should be transmitted during the TXOP.

In some implementations, determining that the urgent PPDU should be transmitted during the TXOP can include: polling one or more devices; and at least based on polling the one or more devices, receiving a response that indicates that a device has the urgent PPDU that should be transmitted during the TXOP.

In some implementations, determining that the urgent PPDU should be transmitted during the TXOP can include, after transmitting one of the two or more PPDUs, determining that a resumption indication was not received within a predetermined period of time. Enabling the transmission of the urgent PPDU can include, at least based on determining that resumption indication was not received within the predetermined period of time, waiting for receipt of a resumption indication before determining whether to transmit, during the TXOP, any remaining PPDUs from the two or more PPDUs. The method can include receiving, while waiting for receipt of the resumption indication, the urgent PPDU from another device.

In some implementations, the method can include, after enabling the transmission of the urgent PPDU, transmitting at least one of the two or more PPDUs.

In some implementations, the method can include, prior to transmitting any of the two or more PPDUs, negotiating a procedure for transmitting a preemption request to indicate that an urgent PPDU should be transmitted. The procedure can indicate a reference in a TXOP from which to transmit a preemption request. The reference can include any PPDU in the TXOP, a BA, or a poll request.

In some implementations, enabling the transmission of the urgent PPDU can include receiving, by an access point from a station, a preemption request for transmission of the urgent PPDU.

In some implementations, enabling the transmission of the urgent PPDU can include waiting, by a station from an access point, for a resumption indication.

In some implementations, a first number of BAs received for the two or more PPDUs can be less than a second number of PPDUs in the two or more PPDUs.

In some implementations, the method can include determining whether there is time left in the TXOP to transmit a last PPDU of the two or more PPDUs; and in response to determining that there is no time left in the TXOP to transmit a last PPDU of the two or more PPDUs, determining to skip transmission of the last PPDU during the TXOP.

A system can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. The operations or actions performed either by the system or by the instructions executed by data processing apparatus can include the operations of any methods described in this specification.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a block diagram of example of electronic devices communicating wirelessly, according to some implementations.

FIGS. 2A-B illustrate example timing diagrams for PPDU transmission.

FIGS. 3A-C illustrate example timing diagrams for PPDU transmission.

FIGS. 4A-C depict example timing diagrams, according to some implementations.

FIG. 5 depicts an example timing diagram, according to some implementations.

FIGS. 6A-B depict example timing diagrams, according to some implementations.

FIG. 7 depicts an example environment for preemption request timing, according to some implementations.

FIG. 8 depicts an example block diagram of distributed resource unit (DRU)

based UORA, according to some implementations.

FIG. 9 illustrates a flowchart of an example method, according to some implementations.

FIG. 10 illustrates a block diagram of an example electronic device, according to some implementations.

### DETAILED DESCRIPTION

Wireless devices, e.g., using IEEE 802.11 wireless standards, can transmit data during a transmit opportunity (TXOP). An access point (AP), such as a wireless router, can determine a duration of the TXOP. For instance, the duration can be 5.548 milliseconds (ms).

When a device is assigned a TXOP, such as a station (STA), the device can transmit (TX) one or more frames of data. The device can transmit, as the one or more frames, physical layer protocol data units (PPDUs). The device can select the PPDUs using any appropriate process. For instance, the device can determine a single PPDU or multiple PPDUs to transmit during the TXOP. The device can determine the one or more PPDUs using a transmission priority of data included in the PPDUs.

While the device transmits data during the TXOP, the device can determine additional data that should be transferred during the TXOP. The additional data can have a higher priority, e.g., urgency, than the original data selected for transmission during the TXOP.

To enable transmission of the additional data during the TXOP, e.g., reducing a latency for the urgent additional data, the device can only transmit PPDUs that do not take up the entire duration of the TXOP, e.g., two or more PPDUs during the TXOP. Each of the PPDUs can have a duration of approximately 1 ms.

To reduce airtime overhead of the transmissions during the TXOP, e.g., caused by the transmission of multiple smaller PPDUs instead of a single larger PPDU, the device can solicit fewer block acknowledgements than would otherwise be required.

To enable transmission of urgent data by other devices, the access point can determine whether there is urgent data that should be transferred during the TXOP using polling or random access for requests from devices connected to the access point during the TXOP. This can enable the transmission of urgent data during a TXOP when multiple devices connected to the same access point might not be able to communicate with each other, e.g., they could be hidden from each other. When the access point is transferring data during the TXOP, the access point can stop transmission to enable transmission of the urgent data. When a first device is transferring data during the TXOP, the access point can poll or otherwise analyze request messages to determine whether there is urgent data that should be transferred. When the access point determines that either there is no urgent data or all urgent data has been transferred, the first device can receive a resumption indication (RE) from the access point.

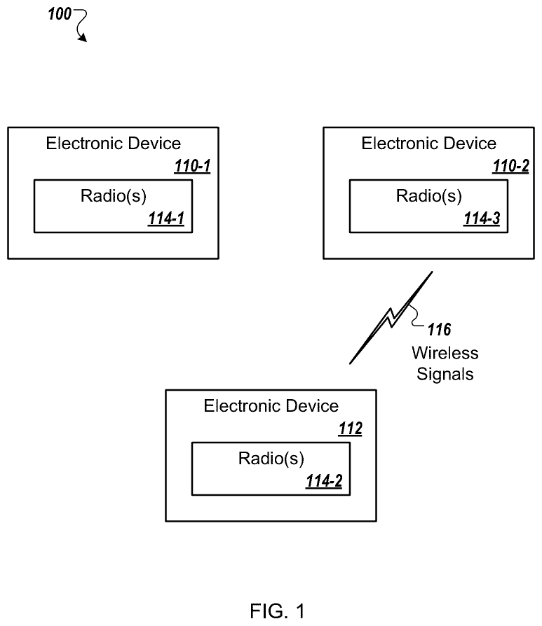

FIG. 1 illustrates a block diagram 100 of example of electronic devices communicating wirelessly, according to some implementations. Notably, one or more electronic devices 110 (such as a smartphone, a laptop computer, a notebook computer, a tablet, or another such electronic device) and access point 112 can communicate wirelessly in a WLAN using an IEEE 802.11 communication protocol. Thus, electronic devices 110 can be associated with or can have a connection with access point 112. For example, electronic devices 110 and access point 112 can wirelessly communicate while: detecting one another by scanning wireless channels, transmitting and receiving beacons or beacon frames on wireless channels, establishing connections (e.g., by transmitting connect requests), and/or transmitting and receiving packets or frames (which can include the request and/or additional information, such as data, as payloads). Note that the access point 112 can provide access to a network, such as the Internet, via an Ethernet protocol, and can be a physical access point or a virtual or “software” access point that is implemented on a computer or an electronic device. In this specification, electronic devices 110 are sometimes referred to as “recipient electronic devices” or “receiver stations.”

Although the environment shown in FIG. 1 is provided as an example, in alternative implementations, different numbers and/or types of electronic devices can be present. For example, some implementations can include more or fewer electronic devices. As another example, in some implementations, different electronic devices can be transmitting and/or receiving packets or frames. In some implementations, multiple links can be used during communication between electronic devices 110.

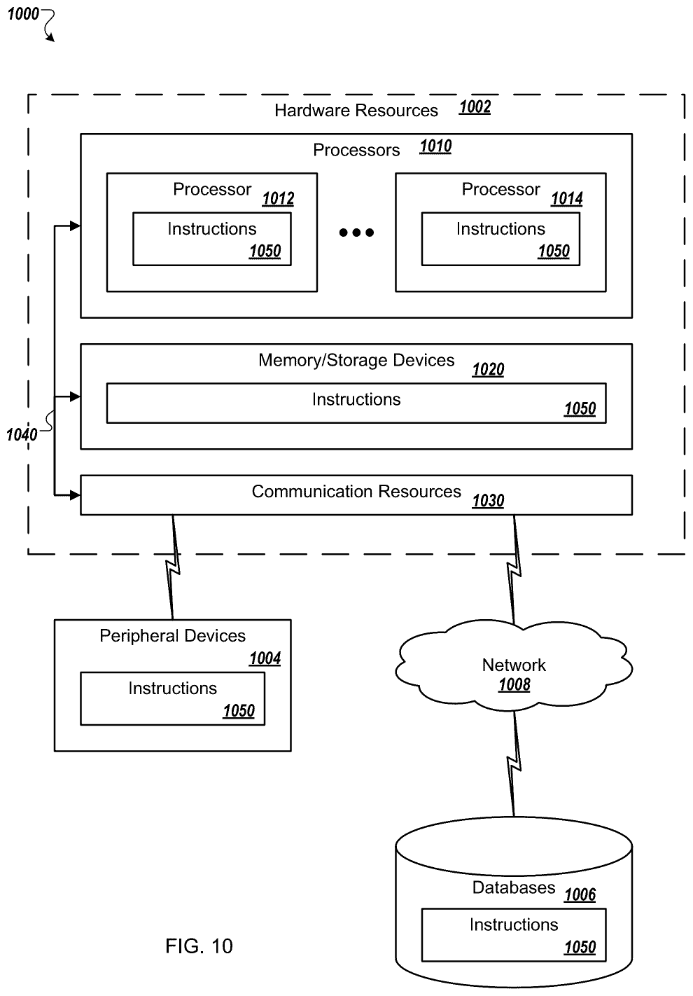

As described further below with reference to FIG. 10, electronic devices 110 and access point 112 can include subsystems, such as a networking subsystem, a memory subsystem, and a processor subsystem. In addition, electronic devices 110 and access point 112 can include radios 114 in the networking subsystems. More generally, electronic devices 110 and access point 112 can include (or can be included within) any electronic devices with networking subsystems that enable electronic devices 110 and access point 112, respectively, to wirelessly communicate with another electronic device. This can include transmitting beacons on wireless channels to enable the electronic devices to make initial contact with or to detect each other, followed by exchanging subsequent data/management frames (such as connect requests) to establish a connection, configure security options, transmit and receive packets or frames via the connection, etc.

As shown in FIG. 1, wireless signals 116 are communicated by one or more radios 114-1 and 114-2 in electronic device 110-1 and access point 112, respectively. For example, as noted previously, electronic device 110-1 and access point 112 can exchange packets or frames using a Wi-Fi communication protocol in a WLAN. Further, one or more radios 114-1 can receive wireless signals 116 that are transmitted by one or more radios 114-2 via one or more links between electronic device 110-1 and access point 112. Alternatively, the one or more radios 114-1 can transmit wireless signals 116 that are received by the one or more radios 114-2.

In some implementations, wireless signals 116 are communicated by one or more radios 114 in electronic devices 110 and access point 112, respectively. For example, one or more radios 114-1 and 114-3 can receive wireless signals 116 that are transmitted by one or more radios 114-2 via one or more links between the electronic devices 110-1 and 110-2, and the access point 112.

In some implementations, the access point 112 can group the electronic devices 110 into a target station set. The target station set concept comes from downlink multi-user transmission where the access point 112 can transmit to multiple stations simultaneously in one PPDU using Orthogonal Frequency Division Multiple Access (OFDMA) or multiuser (MU) Multiple Input Multiple Output (MU-MIMO). Here, the target station set is a set of stations that can simultaneously be served by the access point 112. The stations in the set do not need to share the same PHY parameters, such as MCS, number of streams, etc.

In some implementations, the access point 112 can simultaneously communicate with a plurality of electronic devices 110 using multiuser (MU) techniques, such as MU Multiple Input Multiple Output (MU-MIMO). In some examples, the access point 112 communicates with the electronic devices 110 using frequency multiplexing such that the access point 112 allocates each of the electronic devices a portion of the overall bandwidth. For example, to simultaneously communicate with four electronic devices over an 80 Megahertz (MHz) bandwidth, the access point 112 transmits a MU-PPDU over the 80 MHz bandwidth. The MU-PPDU includes a sub-PPDU for each of the four electronic devices, where each sub-PPDU (or sub-channel) is allocated 20 MHz. The access point 112 can use the MU-PPDU to communicate with devices in the same target set, devices in different target sets, or a combination of both.

In some implementations, access point 112 and one or more electronic devices can be compatible with an IEEE 802.11 standard that includes trigger-based channel access, e.g., IEEE 802.11ax. In 802.11ax, Orthogonal Frequency Division Multiple Access (OFDMA) is used to enable simultaneous communications between the access point 112 and multiple electronic devices. OFDMA divides the available physical spectrum into multiple orthogonal sub-channels, or resource units (RUs), which can be allocated to different electronic devices (users). Under the standard, the access point 112 coordinates multiuser OFDMA by broadcasting a trigger frame which, among other things, allocates a RU to each participating electronic device. Each electronic device responds to the trigger frame by transmitting a PPDU to the access point 112 using the allocated RU. The trigger frame can also include power control information. The access point 112 can instruct all electronic devices 110 when to start and stop transmitting. Note that access point 112 and the electronic devices 110 can communicate with one or more legacy electronic devices that are not compatible with the IEEE 802.11 standard (i.e., that do not use multi-user trigger-based channel access).

In some implementations, processing a packet or frame in one of electronic devices 110 access point 112, or a combination of both, includes: receiving wireless signals 116 encoding a packet or a frame; decoding/extracting the packet or frame from received wireless signals 116 to acquire the packet or frame; and processing the packet or frame to determine information contained in the packet or frame (such as data in the payload).

As discussed previously, one or more of electronic devices 110 and access point 112 can communicate with each other. Notably, access point 112 can transmit a PPDU that includes a preamble and a data field. In some implementations, access point 112 can be configured to use concatenated PPDUs (C-PPDUs), e.g., for low latency communications with receiver stations. A C-PPDU includes a plurality of component PPDUs, each of which includes preamble and a data payload. As described in more detail below, the C-PPDU includes a plurality of component PPDUs. The first component PPDU is preceded by a first preamble called a “full preamble.” The remaining component PPDUs in the C-PPDU are each preceded by respective preambles that are shorter in length than the first preamble. In some implementations, the access point 112 might not perform contention or receive a block acknowledgement (BA) before the plurality of component PPDUs are transmitted.

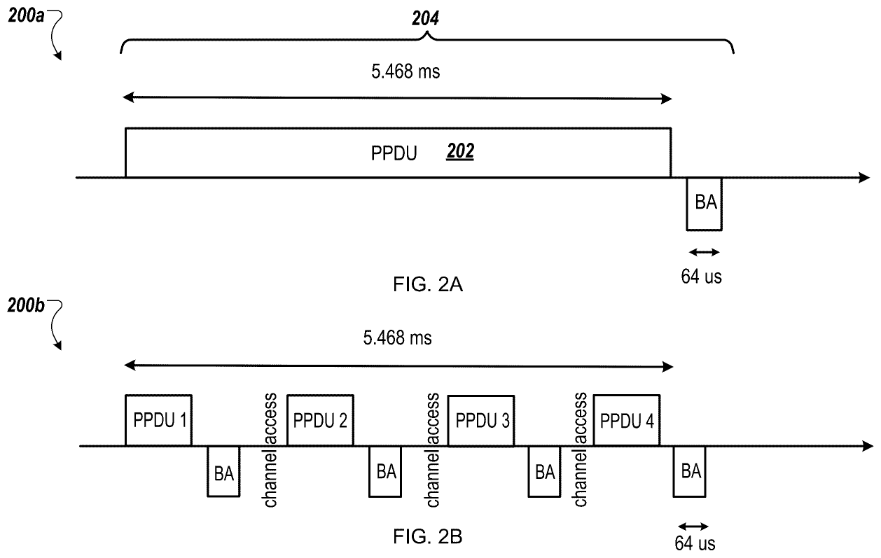

FIGS. 2A-B illustrate example timing diagrams 200a-b for PPDU transmission. In FIG. 2A a device, e.g., a station (STA) or an access point (AP), wants to push out some urgent data with approximately a 1 ms delay bound during transmission its own long PPDU 202. The transmission of the long PPDU 202 can be during a transmission opportunity (TXOP) 204. The long PPDU 202 can have a duration that is approximately the same as the TXOP 204. In some implementations, the long PPDU 202 can have a duration of between approximately 2 ms to 6 ms. The long PPDU include transmission of low priority data. For instance, the long PPDU can include transmission of lower priority data for best effort or background traffic. The lower priority can be less than a higher priority for data transmitted in a high priority PPDU.

FIG. 2B depicts an example timing diagram 200b, according to some implementations. To enable transmission of the urgent data during the TXOP 204, a device can use PPDUs with a duration less than or equal to approximately 1 ms. For instance, when the device is transmitting a CPPDU, the device can transmit a CPPDU with each component PPDU duration less than or equal to 1 ms. In some implementations, this can involve physical hardware changes to the device to enable.

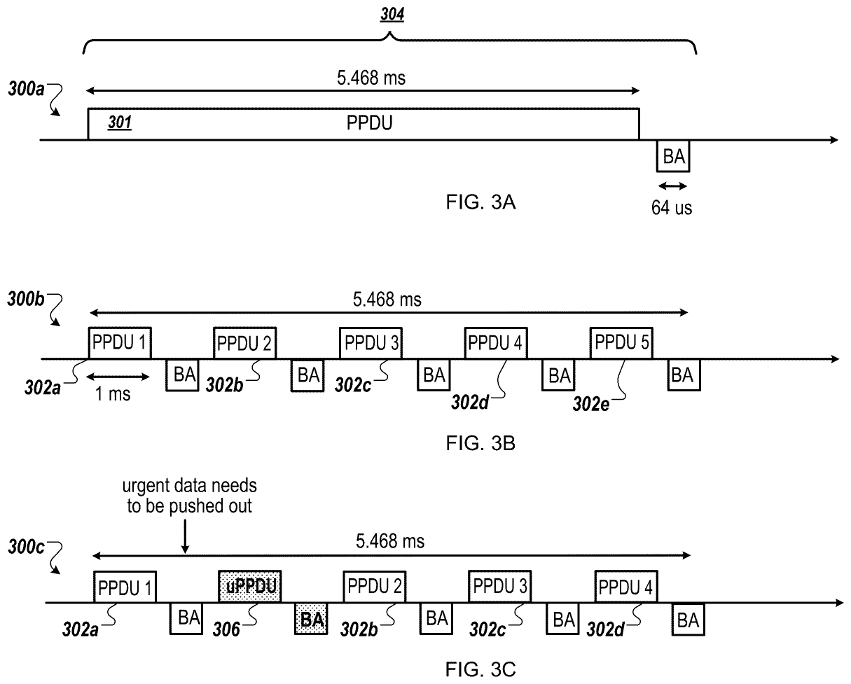

FIGS. 3A-C illustrate example timing diagrams 300a-c for PPDU transmission. Specifically, FIGS. 3B-C illustrate example timing diagrams 300b-c of a MAC software solution with bursting short PPDUs that enables transmission of high priority data during a TXOP 304. During bursting of the short PPDUs 302a-c, a lower priority PPDU 302b during a time period can be replaced by a higher priority PPDU 306, e.g., urgent PPDU or uPPDU, if the transmitting device needs to transmit the higher priority PPDU 306.

Sometimes, an IEEE device's access category such as BE/BK might set TXOPLimit=0, e.g., one TXOP only includes a single PPDU. Hence, after each PPDU transmission, a new channel access is required to continue the transmission as shown in FIG. 2B. When the channel access overhead, e.g., arbitration inter frame spacing (AIFS) plus backoff, is at least approximately 60 us, use of shorter duration PPDUs, e.g., less than or equal to approximately 1 ms can increase the overhead for transmitting multiple PPDUs 302a-d.

To enable PPDU bursting for TXOPLimit=0 and save the airtime overhead, a device can have the total duration of PPDU bursting not exceed the maximum duration of the TXOP 304 with TXOPLimit=0 (5.548 ms). For example, whether bursting or not, when the device is transmitting PPDUs, the device can decide based at least on the existence of an ongoing latency sensitive session whether to transmit a single PPDU during the TXOP 304 or multiple PPDUs 302a-e, 306 that have a maximum duration of the TXOP 304, as shown in FIGS. 3B-C.

In some implementations, the additional overhead of transmitting multiple PPDUs 302a-c, 306 during a TXOP 304 instead of transmitting a single long PPDU 301 can be approximately 11.1%. This additional overhead can be caused by eight additional short interface spaces (SIFS), e.g., for approximately 2.3% overhead, four additional block acknowledgements (BAs), e.g., for approximately 4.7% overhead, and four additional preambles, e.g., for approximately 5.1% overhead assuming a typical 70 us preamble. This additional overhead can be approximately indifferent to whether the device, e.g., an access point, is operating in a multi-user or single-user mode given the 4 us or 8 us preamble size difference.

The device can transmit the higher priority PPDU 306 instead of any of the latter lower priority PPDUs 302b-c. FIG. 3C depicts transmission of the higher priority PPDU 306 during a time period during which the second lower priority PPDU 302b would have been transmitted, as shown in FIG. 3B, absent the higher priority PPDU 306. Instead of or in addition to transmission of the higher priority PPDU 306 during the time period previously for the second lower priority PPDU 302b, the device can transmit higher priority PPDUs during the time periods that would otherwise have been for the third lower priority PPDU 302c, the fourth lower priority PPDU 302d, or the fifth lower priority PPDU 302e.

By transmitting the higher priority PPDU 306 during the TXOP 304, the device is unable to transmit all of the originally planned PPDUs 302a-e during the TXOP 304. Specifically, by transmitting one higher priority PPDU 306, the device won't transmit the last lower priority PPDU 302e, as shown by the lack transmission of the lower priority PPDU 302e in FIG. 3C.

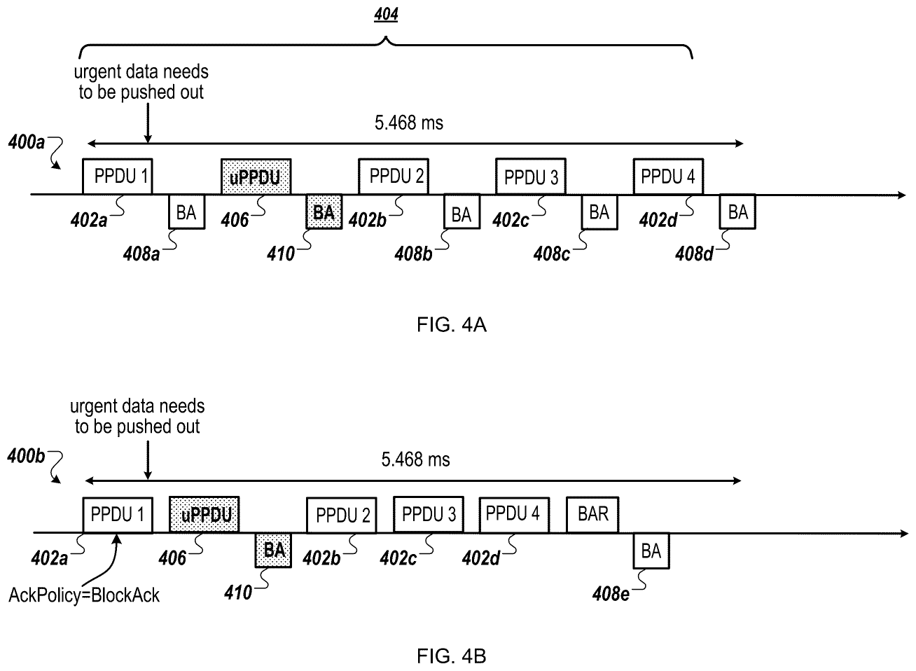

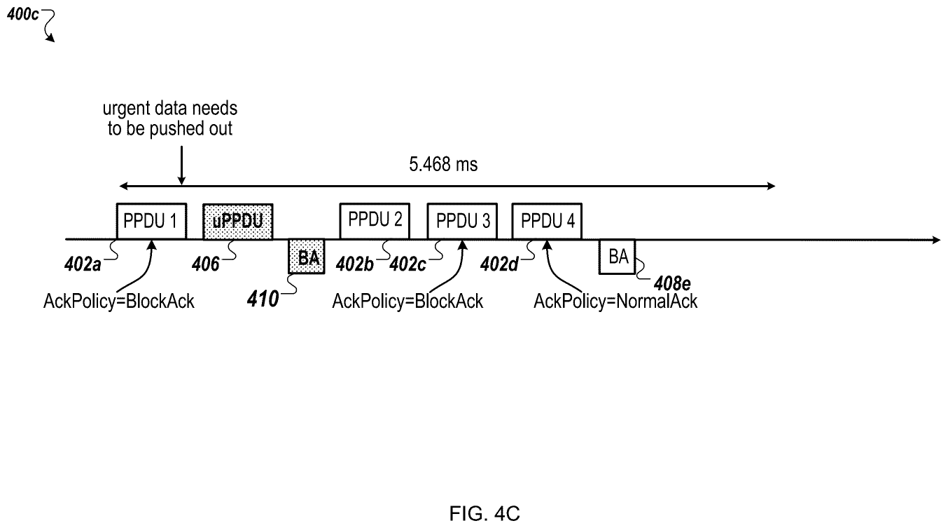

FIGS. 4A-C depict example timing diagrams 400a-c, according to some implementations. For instance, to reduce overhead, a device can use low priority PPDU 402a-dbursting without immediate BA 408a-d. For example, instead of receiving one BA 408a-d after each lower priority PPDU 402a-d, as shown in FIG. 4A, the device can solicit a single BA 408e by sending a Block Ack Request (BAR) frame after the last lower priority PPDU 402d, as shown in FIGS. 4B-C. The device can receive a BA 410 for the higher priority PPDU 406. In some implementations, this can reduce overhead, e.g., over-the-air time, by approximately 4%, e.g., because of two fewer SIFS, approximately three fewer BAs (assuming the duration of BAR is approximately the same as that of BA frame), or both.

In some implementations, by using fewer BAs, bursting PPDUs 402a-e, 406 can have approximately 8% additional overhead compared to transmitting a long PPDU.

In some implementations, the device can indicate whether a recipient device should transmit the BA using an acknowledgement policy. Initial lower priority PPDUs 402a-ccan include an acknowledgement policy that indicates that the recipient device should not transmit a BA, e.g., a block acknowledgement setting. The last lower priority PPDU 402d can include an acknowledgement policy that indicates that the recipient device should transmit a BA 408c, e.g., a normal acknowledgement setting.

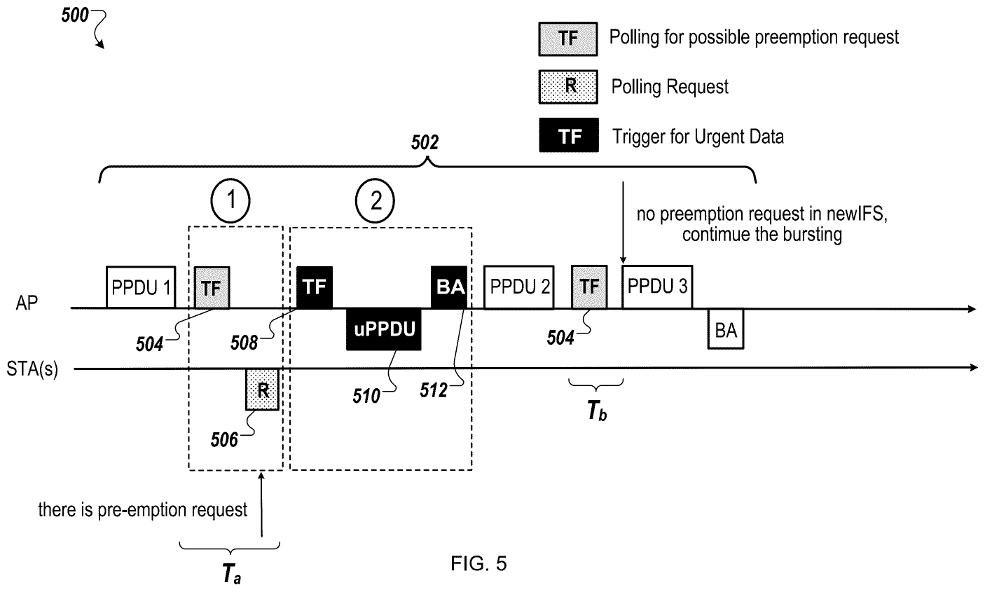

FIG. 5 depicts an example timing diagram 500, according to some implementations. An AP device can use the timing diagram 500 to enable preemption by a different transmitter with urgent data for transmission during a TXOP 502. For instance, the different transmitter, e.g., device such as an STA, can determine to push out urgent data with an approximately 1 ms delay bound during an original device's PPDU transmission. The original device's PPDU transmission can be a long PPDU transmission or a burst of shorter PPDUs.

When the original device is an access point, the device can transmit low priority short PPDU bursts for a maximum of approximately 5 ms. In some examples, the transmitter might solicit an acknowledgment at the end of the burst for other devices with higher priority data for transmission.

To reduce the delay for another device to transmit urgent data, the access point can poll for a preemption request. For instance, the access point can poll other devices connected to the access point using one or more polling requests 504. If the access point does not receive preemption request 506, as shown during time period Tb, the access can continue bursting the lower priority PPDUS.

If the access point receives a preemption request 506 from another device, e.g., a STA, as shown during time period Tₐ, the access point can stop bursting the lower priority PPDUs and enable the other device to transmit one or more PPDUs with the higher priority, e.g., urgent, data. For instance, the access point can transmit a trigger 508 to the other device that indicates that the other device can transmit the one or more PPDUs with the higher priority data.

After the other device, e.g., prior recipient device, transmits the higher priority PPDU 510, the access point can transmit a BA 512 to the other device. When other devices are the intended recipients for the higher priority PPDU 510, the access point can transmit the BA 512 to the other devices.

In some implementations, when there are multiple devices communicating on a network, not all of the devices might receive any particular PPDU. For example, the access point might transmit the lower priority PPDUs to a first device, determine that a second device has a higher priority PPDU for transmission, and enable the second device to transmit the higher priority PPDU. The recipients of the higher priority PPDU can include the first device, a third device, or some combination of these devices, but not necessarily all of them.

In some implementations, not all of the devices might be aware of the other devices on the network, e.g., some devices might be hidden from other devices. For instance, the access point is aware of all devices that connect to the access point including the first and second devices, but the first device might not be aware of the second device.

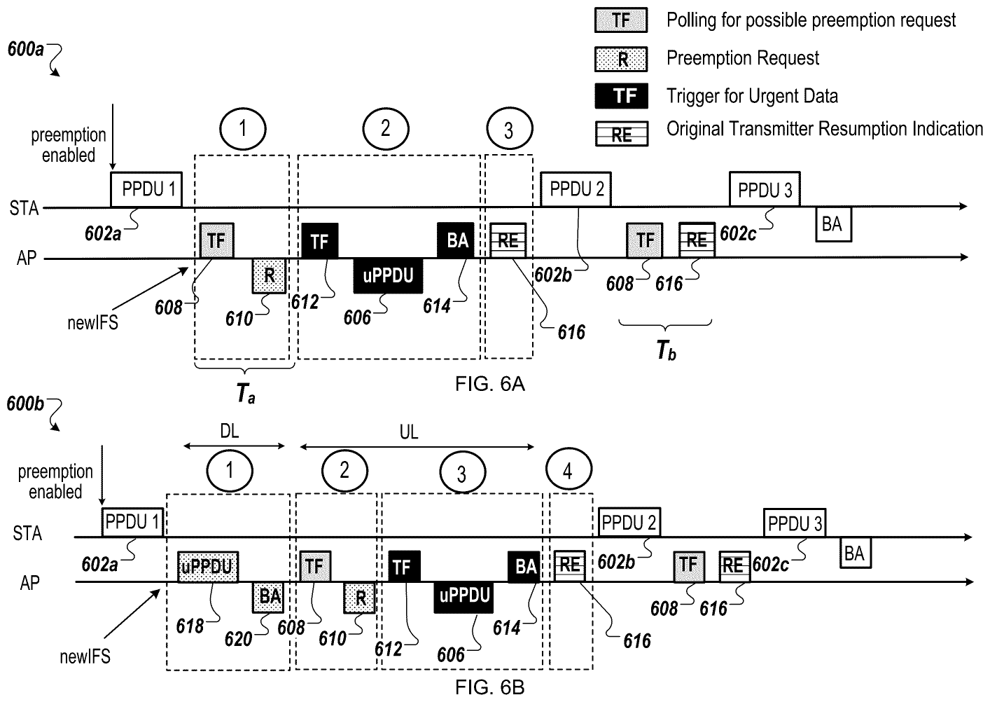

FIGS. 6A-B depict example timing diagrams 600a-b, according to some

implementations. For example, when a device other than the access point is transmitting data during a TXOP, since the device might not be aware of all other devices on the network, the device needs the access point's help to enable transmission of higher priority data during the TXOP. The timing diagrams 600a-b use communication with an access point to enable transmission of higher priority data by devices other than a device originally assigned to the TXOP to enable transmission by devices of which the original device might be unaware. FIG. 6A depicts an example of higher priority data from other devices not including the access point, e.g., other STAs. FIG. 6B depicts an example of higher priority data from other devices including both the access point and another device, e.g., another STA. In some examples, instead of higher priority data from both the access point and the other device, the timing diagram 600b can be used for only higher priority data from the access point.

In FIGS. 6A-B, after the original device transmits a first lower priority PPDU 602a, the original device can use a new inter frame spacing (newIFS) to determine whether another device has a higher priority PPDU for transmission. For example, the original device can wait while an access point transmits a trigger 608 as part of a polling process. If the access point does not receive a response to the trigger 608, the access point can transmit a resumption indication 616, as indicated during time period Tb. The original device can receive the resumption indication 616 and continue transmitting any of the remaining lower priority PPDUs 602c.

If the access point receives a preemption request 610 from a device with high priority data for transmission, the access point can transmit a trigger 612 to the device. In response, the device can transmit the higher priority PPDU 606. The access point can transmit a BA 614 to the device once the device completes transmission of the higher priority PPDU 606. After transmitting the BA 614, the access point can transmit the resumption indication 616 to the original device. The original device can receive the resumption indication 616 and continue transmitting any of the remaining lower priority PPDUs 602b.

When the access point has high priority data for transmission, instead of transmitting the trigger 608, the access point can transmit a higher priority PPDU 618, as shown in FIG. 6B. After receiving a BA 620, the access point can proceed with the trigger 608 as described with reference to FIG. 6A. After transmitting the trigger 608, the access point can either receive a preemption request 610 or not, as indicated for the time periods Tₐ and T_{b}, respectively. Once the access point determines that no higher priority data has been identified for transmission, the access point can transmit the resumption indication 616 to the original device. Upon receipt of the resumption indication, the original device can continue transmitting lower priority PPDUs.

The trigger 608, the resumption indication 616, or both, can be optimized. For instance, one or both might not have a MAC payload. The trigger 608, the resumption indication 616, or both, can be approximately 40 us long.

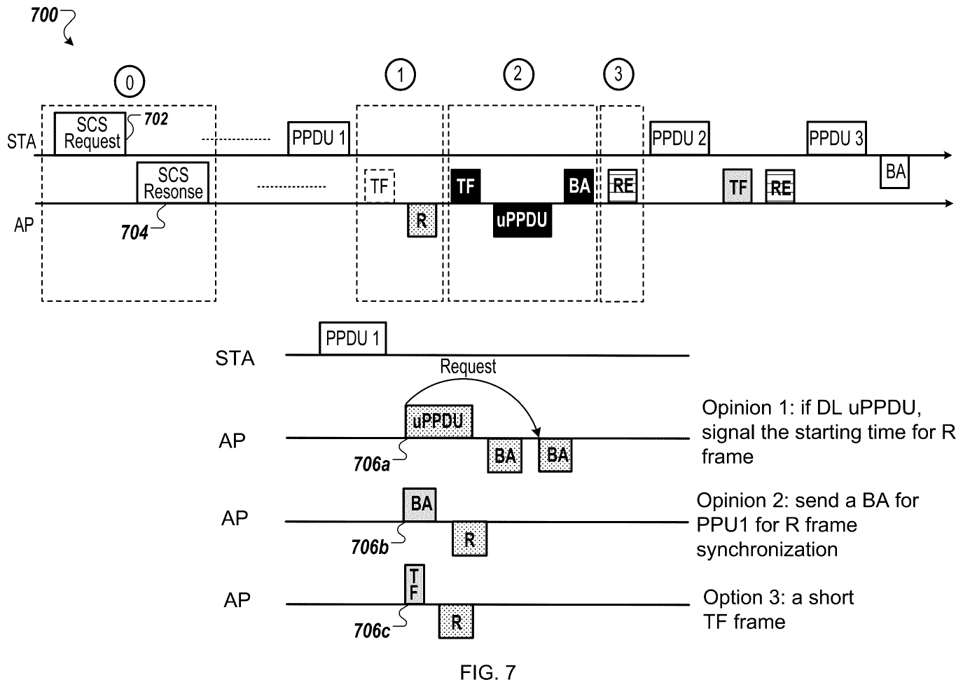

FIG. 7 depicts an example environment 700 for preemption request timing, according to some implementations. An access point can negotiate with devices for when the devices can transmit a preemption request during a TXOP. In some examples, the access point can use the 802.11 Stream Classification Service (SCS) procedure to indicate one or more parameters for the preemption request. The parameters can include when to transmit a preemption request, what to include in a preemption request, or a combination of both. The SCS procedure negotiation can include an SCS request 702, e.g., transmitted from a device such as an STA, and an SCS response 704, e.g., transmitted from the access point.

The parameters can indicate that the preemption request should be transmitted at a time determined from a reference point 706a-c. The reference point 706a can be a higher priority PPDU transmitted by the access point. The reference point 706b can be a BA transmitted by the access point. The reference point 706c can be a short trigger transmitted by the access point. In some implementations, when most information carried in the trigger frame has been included in SCS response frame, such a short trigger is possible by avoiding duplicating the information.

The parameters can indicate multiple reference points 706a-c. For instance, the parameters can indicate that either a higher priority PPDU or a trigger transmitted by the access point can be used as the reference point.

In some implementations, if an access point skips use of a trigger frame, then the access point synchronizes the preemption request frames from other devices. The access point can do this using DL PPDU, e.g., uPPDU, to indicate the preemption request frame transmission time, or transmit a BA frame for a lower priority PPDU as the synchronization point, e.g., assuming that other devices listen to this BA.

In some implementations, if the access point receives preemption requests from more than one device, the access point can use triggered uplink access to enable concurrent transmission from multiple devices. The multiple devices can include the original device.

In some implementations, when the access point uses triggered uplink access, certain bands might be empty. The empty bands could be unprotected and grabbed by some other device, e.g., STA. To address this, the access point can use distributed resource units (DRUs), as discussed in more detail below.

The preemption request can include any appropriate data. For instance, the preemption request can include a device identifier, a buffer status (BSR), or a combination of both. In some examples, the preemption request can occupy the whole operating bandwidth to avoid large idle gap, e.g., in a 20 MHz channel.

In some implementations, an access point can support receipt of multiple preemption requests from different devices, e.g., STAs.

The preemption request can be polling based or random access based. For polling based, the preemption request can be resource unit based polling or trigger based (TB) null data packet (NDP) feedback. For random access based, the preemption request can be uplink OFDMA random access (UORA) or DRU based UORA.

Resource unit based polling can include pre-assigning each RU to a device, an access point trigger R frame, a device with urgent data transmit request on the pre-assigned RU, including STA ID, BSR etc., or a combination of two or more of these. In some implementations, RU based polling might not occupy the whole operating bandwidth using DRU; might provide limited polling for devices, e.g., STAs with 106 tone RU, up to 8 STAs in 80 MHz; might need management of RU to STA mapping; or a combination of these. RU based polling can be easy to implement, capable of including all necessary information, or both, which can provide advantages compared to other systems.

TP NDP feedback can include reuse of TB NDP feedback for polling, each registered device can be pre-assigned to one of the twelve tone set in TB NDP, or both. In some implementations, TD NDP feedback might not occupy the whole operating bandwidth, might only carry one bit of information, e.g., BSR might not be able to be transmit, might need management of RU to TB NDP tone set mapping, or a combination of these. TD NDP feedback can enable polling up to 144 devices in 80 MHz TP NDP feedback, which can provide advantages compared to other systems.

UORA can include using one round of UORA for random access, a device with urgent data can randomly pick an RU to transmit the contention frame, or both. In some implementations, UORA might not occupy the whole operating bandwidth, might have limited RA-RU number for contention, e.g., might have a collision, or a combination of both. This can enable the use of a simpler protocol, e.g., without device to RU mapping, include all the necessary information, or both, which can provide advantages compared to other systems.

DRU based UORA can include UORA with distributed RU (DRU) for random access, can spread tones across the whole operating bandwidth, can be used in a polling based scheme, or a combination of these. In some implementations, DRU based UORA might have a limited RA-DRU number for contention, e.g., might have a collision. DRU based UORA can enable a simpler protocol, e.g., without a device to RU mapping, include all necessary information, increase a likelihood that the primary channel is always occupied, e.g., when polling devices for higher priority data, or a combination of these, which can provide advantages compared to other systems.

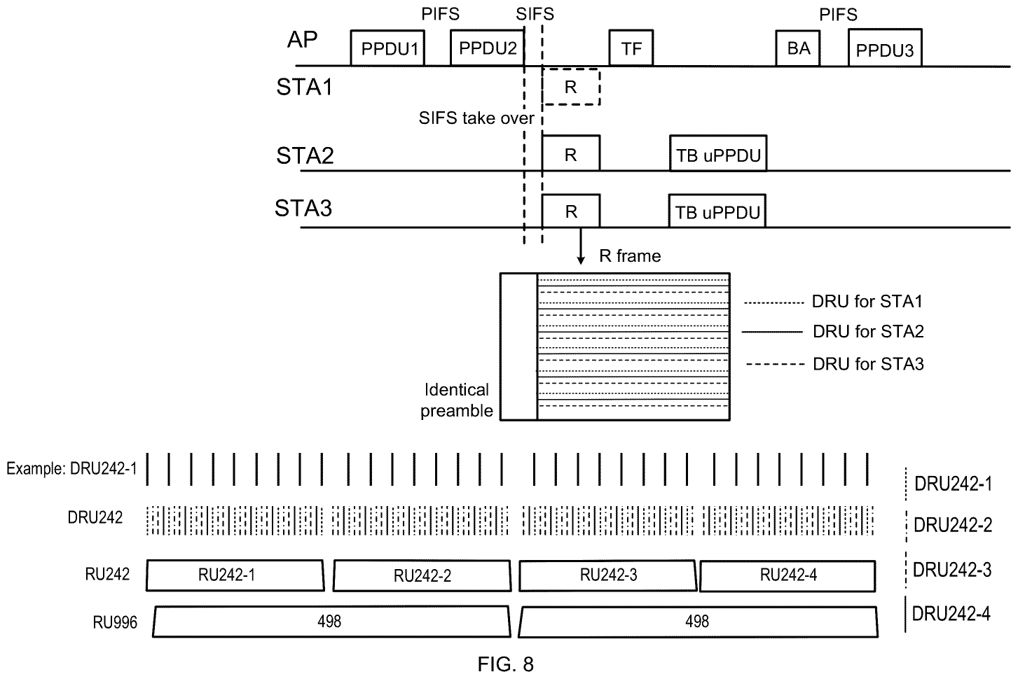

FIG. 8 depicts an example block diagram 800 of distributed resource unit (DRU) based UORA, according to some implementations. DRU is introduced in 802.11bn. One use of DRU is to extend the range in PSD limited LPI channel. In DRU, when a device has urgent data, the device can randomly select a DRU and transmit the preemption request frame SIFS after a burst PPDU. The preemption request frame can have an identical preamble. If multiple devices have urgent data, they can transmit preemption request frames simultaneously on different DRU. A collision can occur if the same DRU is selected by multiple devices.

In some implementations, if a device has urgent data, the device can notify the access point using a SCS request frame. If the access point has only a few such devices, e.g., less than ten, with urgent data, the access point can include “fixed BSRP trigger frame Common Info and Per User Info” in the SCS Response frame. If the access point has tens of such devices, the access point can use NFRP trigger frame, e.g., fixed Starting AID field, and change the AIDs for these devices such that AIDs of devices with urgent data belong to a continuous range.

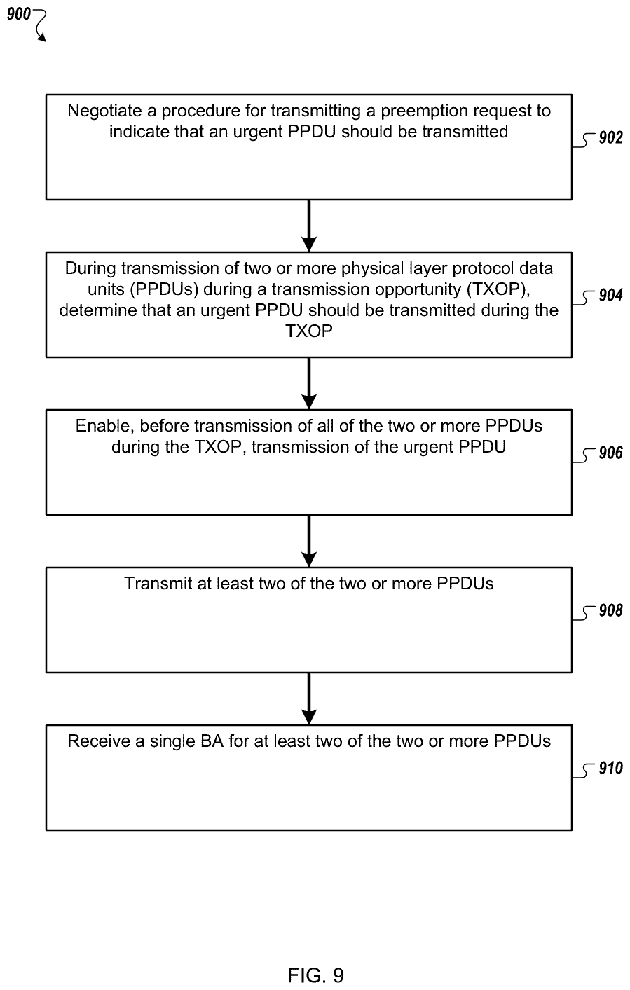

FIG. 9 illustrates a flowchart of an example method 900, according to some implementations. For clarity of presentation, the description that follows generally describes method 900 in the context of the other figures in this description. For example, method 900 can be performed by device of FIG. 1. It will be understood that method 900 can be performed, for example, by any suitable system, environment, software, hardware, or a combination of systems, environments, software, and hardware, as appropriate. In some implementations, various steps of method 900 can be run in parallel, in combination, in loops, or in any order.

A device negotiates a procedure for transmitting a preemption request to indicate that an urgent PPDU should be transmitted (902). The device can be an access point or a station.

During transmission of two or more physical layer protocol data units (PPDUs) during a transmission opportunity (TXOP), the device determines that an urgent PPDU should be transmitted during the TXOP (904). The device can determine that the device itself needs to transmit the urgent PPDU or another device needs to transmit the urgent PPDU. When another device needs to transmit the urgent PPDU, the device can be or can communicate with an access point to determine that an urgent PPDU should be transmitted during the TXOP.

The device enables, before transmission of all of the two or more PPDUs during the TXOP, transmission of the urgent PPDU (906). For instance, when the device needs to transmit the urgent PPDU, the device can pause sending the lower priority PPDUs and send the urgent PPDU. When another device needs to transmit the urgent PPDU, the device can determine to wait until after the urgent PPDU is transmitted to continue transmitting lower priority PPDUs.

In some implementations, after the urgent PPDU is transmitted, the device can determine whether any lower priority PPDUs can be transmitted during the TXOP. In response to determining that another lower priority PPDU cannot be transmitted during the TXOP, e.g., the remaining duration of the TXOP is insufficient for transmission of another PDU, the device can determine to skip transmission of another PPDU during the TXOP.

The device transmits at least two of the two or more PPDUs (908). For instance, in response to determining that a lower priority PPDU can be transmitted, e.g., the remaining duration of the TXOP is sufficient for transmission of another PPDU, the device can transmit a lower priority PPDU that was not yet transmitted, e.g., from the two or more PPDUs.

The device can transmit the two PPDUs at any appropriate time. For instance, the device can transmit both PPDUs after enabling transmission of the urgent PPDU. In some implementations, the device can transmit a first PPDU before determining that an urgent PPDU should be transmitted during the TXOP and a second PPDU after enabling transmission of the urgent PPDU, e.g., after the urgent PPDU is transmitted.

The device receives a single BA for at least two of the two or more PPDUs (910). For instance, the device can use a BAR to solicit the single BA, an acknowledgement policy, e.g., included in a lower priority PPDU, or another appropriate mechanism.

The example method 900 shown in FIG. 9 can be modified or reconfigured to include additional, fewer, or different steps (not shown in FIG. 9), which can be performed in the order shown or in a different order. In some implementations, the method 900 can include operations 904 and 906 without the other operations. In some implementations, the method 900 can include operations 902 through 906 without the other operations. The method 900 can include operations 904 through 908 without the other operations. The method 900 can include operations 904 through 910 without the other operations.

FIG. 10 illustrates a block diagram of an electronic device 1000, according to some implementations. The electronic device 1000 can be a cellular telephone, a smartwatch, an access point, a wireless speaker, an Internet-of-Things (IoT) device, among other examples. The electronic device 1000 includes hardware resources 1002 that include one or more processors (or processor cores) 1010, one or more memory/storage devices 1020, and one or more communication resources 1030, each of which can be communicatively coupled via a bus 1040.

The one or more processors 1010 include one or more devices configured to perform computational operations. For example, the one or more processors 1010 can include one or more microprocessors, application-specific integrated circuits (ASICs), microcontrollers, graphics processing units (GPUs), programmable-logic devices, and/or one or more digital signal processors (DSPs). The processors 1010 can include, for example, a processor 1012 and a processor 1014. The processor(s) 1010 can be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1020 can include main memory, disk storage, or any suitable combination thereof. The memory/storage devices 1020 can include, but are not limited to, any type of volatile or nonvolatile memory such as dynamic random-access memory (DRAM), static random-access memory (SRAM), erasable programmable read-only memory (EPROM), electrically erasable programmable read-only memory (EEPROM), Flash memory, solid-state storage, etc. In some implementations, the memory/storage devices 1020 are coupled to one or more high-capacity mass-storage devices (not shown). In some examples, memory/storage devices 1020 can be coupled to a magnetic or optical drive, a solid-state drive, or another type of mass-storage device. In these examples, the memory/storage devices 1020 can be used by electronic device 1000 as fast-access storage for often-used data, while the mass-storage device is used to store less frequently used data.

The communication resources 1030 can include interconnection or network interface components or other suitable devices to communicate with one or more peripheral devices 1004 or one or more databases 1006 via a network 1008. For example, the communication resources 1030 can include wired communication components (e.g., for coupling via USB), cellular communication components, NFC components, Bluetooth® (or Bluetooth® Low Energy) components, Wi-Fi® components, and other communication components.

The communication resources 1030 include one or more devices configured to couple to and communicate on a wired and/or wireless network (i.e., to perform network operations), such as: control logic, one or more interface circuits and a set of antennas (or antenna elements) in an adaptive array that can be selectively turned on and/or off by control logic to create a variety of optional antenna patterns or “beam patterns.” Alternatively, instead of the set of antennas, in some examples, electronic device 1000 includes one or more nodes, e.g., a pad or a connector, which can be coupled to the set of antennas. Thus, electronic device 1000 might or might not include the set of antennas. For example, communication resources 1030 can include a Bluetooth™ networking system, a cellular networking system (e.g., a 3G/4G/5G/6G network such as UMTS, LTE, etc.), a universal serial bus (USB) networking system, a networking system based on the standards described in IEEE 802.11 (e.g., a Wi-Fi® networking system), an Ethernet networking system, and/or another networking system.

In some implementations, communication resources 1030 includes one or more radios, such as a wake-up radio that is used to receive wake-up frames and wake-up beacons, and a main radio that is used to transmit and/or receive frames or packets during a normal operation mode. The wake-up radio and the main radio can be implemented separately (such as using discrete components or separate integrated circuits) or in a common integrated circuit.

The communication resources 1030 include processors, controllers, radios/antennas, sockets/plugs, and/or other devices used for coupling to, communicating on, and handling data and events for each supported networking system. Note that mechanisms used for coupling to, communicating on, and handling data and events on the network for a network system are sometimes collectively referred to as a “network interface” for the network system.

Instructions 1050 can comprise software, a program, an application, an applet, an app, or other executable code for causing at least any of the processors 1010 to perform any one or more of the methodologies discussed herein. The instructions 1050 can reside, completely or partially, within at least one of the processors 1010 (e.g., within the processor's cache memory), the memory/storage devices 1020, or any suitable combination thereof. In some implementations, any portion of the instructions 1050 can be transferred to the hardware resources 1002 from any combination of the peripheral devices 1004 or the databases 1006. Accordingly, the memory of processors 1010, the memory/storage devices 1020, the peripheral devices 1004, and the databases 1006 are examples of computer-readable and machine-readable media.

While the preceding discussion used a Wi-Fi communication protocol as an illustrative example, in other implementations a wide variety of communication protocols and, more generally, wireless communication techniques can be used. Thus, the communication techniques can be used in a variety of network interfaces. Furthermore, while some of the operations in the preceding implementations were implemented in hardware or software, in general the operations in the preceding implementations can be implemented in a wide variety of configurations and architectures. Therefore, some or all of the operations in the preceding implementations can be performed in hardware, in software or a combination of both. For example, at least some of the operations in the communication techniques can be implemented using instructions 1050, operating system (such as a driver for an interface circuit in communication resources 1030) or in firmware in an interface circuit in communication resources 1030. Additionally or alternatively, at least some of the operations in the communication techniques can be implemented in a physical layer, such as hardware in an interface circuit in communication resources 1030. In some implementations, the communication techniques are implemented, at least in part, in a MAC layer and/or in a physical layer in an interface circuit in communication resources 1030.

While the preceding implementations illustrated the use of wireless signals in one or more bands of frequencies, in some implementations, electromagnetic signals in one or more different frequency bands are used to determine the range. For example, these signals can be communicated in one or more bands of frequencies, including: a microwave frequency band, a radar frequency band, 900 MHz, 2.4 GHz, 5 GHZ, 6 GHz, 60 GHz, and/or a band of frequencies used by a Citizens Broadband Radio Service, by LTE, 5G, or any other communication system.

Although specific components are used to describe electronic device 1000, in some implementations, different components and/or subsystems can be present in electronic device 1000. For example, electronic device 1000 can include one or more additional processing subsystems, memory subsystems, networking subsystems, and/or display subsystems. Additionally, one or more of the subsystems might not be present in electronic device 1000. In some implementations, electronic device 1000 can include one or more additional subsystems that are not shown in FIG. 10. In some implementations, electronic device can include an analysis subsystem that performs at least some of the operations in the communication techniques. Although separate subsystems are shown in FIG. 10, in some implementations some or all of a given subsystem or component can be integrated into one or more of the other subsystems or component(s) in electronic device 1000.

Although the implementations above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

We claim:

1. A method comprising:
during transmission of two or more physical layer protocol data units (PPDUs) during a transmission opportunity (TXOP), determining that an urgent PPDU should be transmitted during the TXOP; and
enabling, before transmission of all of the two or more PPDUs during the TXOP, transmission of the urgent PPDU.

2. The method of claim 1, comprising:
receiving a block acknowledgement (BA) for the urgent PPDU; and
receiving a single BA for at least two of the two or more PPDUs.

3. The method of claim 2, comprising after enabling the transmission of the urgent PPDU, transmitting at least two of the two or more PPDUs,
wherein receiving the single BA comprises receiving the single BA for the two of the two or more PPDUs.

4. The method of claim 1, wherein determining that the urgent PPDU should be transmitted during the TXOP comprises determining that the urgent PPDU with an approximately 1 millisecond delay bound should be transmitted during the TXOP.

5. The method of claim 1, wherein determining that the urgent PPDU should be transmitted during the TXOP comprises:
polling one or more devices; and
at least based on polling the one or more devices, receiving a response that indicates that a device has the urgent PPDU that should be transmitted during the TXOP.

6. The method of claim 1, wherein:
determining that the urgent PPDU should be transmitted during the TXOP comprises after transmitting one of the two or more PPDUs, determining that a resumption indication was not received within a predetermined period of time; and
enabling the transmission of the urgent PPDU comprises, at least based on determining that resumption indication was not received within the predetermined period of time, waiting for receipt of a resumption indication before determining whether to transmit, during the TXOP, any remaining PPDUs from the two or more PPDUs.

7. The method of claim 6, comprising receiving, while waiting for receipt of the resumption indication, the urgent PPDU from another device.

8. The method of claim 1, comprising after enabling the transmission of the urgent PPDU, transmitting at least one of the two or more PPDUs.

9. The method of claim 1, comprising prior to transmitting any of the two or more PPDUs, negotiating a procedure for transmitting a preemption request to indicate that an urgent PPDU should be transmitted.

10. The method of claim 9, wherein the procedure indicates a reference in a TXOP from which to transmit a preemption request.

11. The method of claim 10, wherein the reference comprises any PPDU in the TXOP, a BA, or a poll request.

12. The method of claim 1, wherein enabling the transmission of the urgent PPDU comprises receiving, by an access point from a station, a preemption request for transmission of the urgent PPDU.

13. The method of claim 1, wherein enabling the transmission of the urgent PPDU comprises waiting, by a station from an access point, for a resumption indication.

14. The method of claim 1, wherein a first number of BAs received for the two or more PPDUs is less than a second number of PPDUs in the two or more PPDUs.

15. A method comprising:
transmitting, during a transmission opportunity (TXOP), a first physical layer protocol data unit (PPDU) of two or more PPDUs each of which are scheduled for transmission during the TXOP;
determining that an urgent PPDU should be transmitted during the TXOP; and
transmitting, before transmission of all of the two or more PPDUs during the TXOP, the urgent PPDU that has a duration that fits in a TXOP and that was not included in the two or more PPDUs.

16. The method of claim 15, comprising:
determining whether there is time left in the TXOP to transmit a last PPDU of the two or more PPDUs; and
in response to determining that there is no time left in the TXOP to transmit a last PPDU of the two or more PPDUs, determining to skip transmission of the last PPDU during the TXOP.

17. An apparatus comprising one or more processors configured to perform operations comprising:
during transmission of two or more physical layer protocol data units (PPDUs) during a transmission opportunity (TXOP), determining that an urgent PPDU should be transmitted during the TXOP; and
enabling, before transmission of all of the two or more PPDUs during the TXOP, transmission of the urgent PPDU.

18. The apparatus of claim 17, the operations comprising:
receiving a block acknowledgement (BA) for the urgent PPDU; and
receiving a single BA for at least two of the two or more PPDUs.

19. The apparatus of claim 18, the operations comprising after enabling the transmission of the urgent PPDU, transmitting at least two of the two or more PPDUs,
wherein receiving the single BA comprises receiving the single BA for the two of the two or more PPDUs.

20. The apparatus of claim 17, wherein determining that the urgent PPDU should be transmitted during the TXOP comprises determining that the urgent PPDU with an approximately 1 millisecond delay bound should be transmitted during the TXOP.
